(19) United States
(12) Patent Application Publication
(10) Pub. No.: US 2010/0318726 A1
(43) Pub. Date: Dec. 16, 2010

(54) MEMORY SYSTEM AND MEMORY SYSTEM MANAGING METHOD

(75) Inventor: Yuichiro WATANABE, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/752,476

(22) Filed: Apr. 1, 2010

(30) Foreign Application Priority Data
Jun. 11, 2009 (JP) 2009-140340

(51) Int. Cl. G06F 12/00; G06F 12/10; G06F 12/02

(52) U.S. Cl. 711/103; 711/209; 711/206; 711/E12.001; 711/E12.008; 711/E12.059

(57) ABSTRACT

Correspondences between logical blocks and physical blocks of first and second memories are controlled such that an identical logical block is subject to correspondence with a physical block of the first memory and to a physical block of the second memory, and data is stored in the physical blocks subject to correspondence with the identical logical block such that pages that contain data do not overlap between the physical blocks so that operation performed on the first memory and operation performed on the second memory can be performed in parallel, thereby achieving speedup and an increase in efficiency in data writing to non-volatile memory, to which overwriting is inapplicable and to which writing involves block-to-block data move.

### CROSS-REFERENCE TO RELATED APPLICATIONS

This application is based upon and claims the benefit of priority from the prior Japanese Patent Application No. 2009-140340, filed on Jun. 11, 2009; the entire contents of which are incorporated herein by reference.

### BACKGROUND OF THE INVENTION

1. Field of the Invention

The present invention relates to a memory system that includes non-volatile semiconductor memory and to a memory system managing method.

2. Description of the Related Art

NAND flash memory is known as one of electrically erasable programmable non-volatile semiconductor memory (EEPROM). NAND flash memory has its cell size smaller than that of NOR flash memory and is easy to increase storage capacity. To make use of such a feature, NAND flash memory is used as various types of recoding media including file memory and a memory card.

### SUMMARY OF THE INVENTION

According to one aspect of the present invention, a memory system includes non-volatile first and second memories that are capable of operating in parallel and respectively have a plurality of physical blocks which respectively include a plurality of pages; and a controller that controls reading and writing from and to the first and second memories, wherein the controller includes: an address control unit that performs address management of managing correspondences between logical blocks and the physical blocks of the first and second memories such that an identical logical block is subject to correspondence with a respective physical block of the first and second memories, and storing data of pages included in the identical logical block such that, between physical blocks subject to correspondence with the identical logical block, pages including data do not overlap with each other, the address control unit includes: a first control unit that performs, when a write-requested page is unused in both of the first and second memories, first control of writing write-requested data to the write-requested page in any one of the first and second memories; a second control unit that performs, when the write-requested page is in use in any one of the first and second memories, second control of writing write-requested data to the write-requested page of one of the memories that is not in use, and writing storage data of page other than the write-requested page of the memory that is in use, to an unused physical block of the memory side that is in use; and a third control unit that performs, when the write-requested page is in use in both of the first and second memories, third control of writing to an unused physical block of the first memory side, data of a page that is overlapped with a page used in the second memory within the write-requested data, and storage data of page other than a page that is overlapped with the write-requested data within the storage data of a page used in the first memory, and of writing to an unused physical block of the second memory side, data of a page that is overlapped with a page used in the first memory within the write-requested data, and storage data of a page other than a page that is overlapped with the write-requested data within the storage data of a page used in the second memory, and the second and third control units perform operation to the first memory and operation to the second memory in parallel.

### BRIEF DESCRIPTION OF THE DRAWINGS

FIG. 1 is a block diagram illustrating a system configuration according to an embodiment of the present invention;

FIG. 2 is a schematic diagram illustrating logical-physical mapping providing correspondences between logical addresses and physical addresses;

FIG. 3 is a diagram illustrating an example of a block management table;

FIG. 4 is a diagram illustrating an example of a page management table;

FIG. 5 is a diagram illustrating an example of an unused-block management table;

FIG. 6 is a diagram illustrating an example of an used-block management table;

FIG. 7 is a flowchart illustrating an operation sequence of writing operation;

FIG. 8 is a diagram illustrating an example of the writing operation;

FIG. 9 is a diagram illustrating another example of the writing operation;

FIG. 10 is a diagram illustrating another example of the writing operation;

FIG. 11 is a flowchart illustrating a sequence of operations of defragmentation; and

FIG. 12 is a schematic diagram illustrating the defragmentation.

### DETAILED DESCRIPTION OF THE INVENTION

In NAND flash memory, data erasing is performed on a block basis, where each of the block is defined as a set of NAND cell units (NAND string) arranged along a direction of word lines. The block includes a plurality of pages, and write/erase is typically performed on a page basis. To rewrite data stored in a given block, it is necessary to erase all data at one time from the block before performing writing.

In a field of technology of such NAND flash memory, in order to simplify wear leveling process and garbage collection process, a block management scheme that performs management by using block, rather than page, as a management unit is known. The block management scheme manages only correspondences between logical block addresses to be used by a host apparatus and physical block addresses to be used by NAND flash memory, but does not manage pages contained in each block. Accordingly, in the block management scheme, management is performed such that data of a logical page contained in a given logical block address is stored in a physical page specified by a physical block address that is brought into correspondence with the logical block address.

In such a block management, there can be cases where a write request is issued to some logical pages of a plurality of logical pages that already contain valid data. In such a case, in a block management, data move operation is performed as follows. That is, write-requested page data is written to an spare block; thereafter, other page data, which is not write-requested page data in the physical block corresponding to the logical block including some logical pages to which write-request is generated, is copied to the spare block. Further, changing of correspondence is performed in such a manner that the logical block address of the logical block to which write-request is generated is subject to correspondence with the physical block address of the spare block. The original physical block, to which a write request has initially been requested is then erased to become an unused block.

Such data move operation requires repeatedly performing a cycle of reading data from a block and writing the data to another block on a page basis, making data processing time long. As discussed above, the block management is disadvantageous in that because block-to-block data move occurs more frequently than in the page management, which can adversely affect performance of a host system that uses NAND flash memory.

JP-A 2002-366423 (KOKAI) discloses a technique related to a flash memory that includes a data block and a log block that stores information about modification of the data block, and that is configured such that when a write request is issued to a page to which data is already recorded, write to a log block corresponding to a data block containing the write-requested page is performed while when a write request to the page is issued again, write to an empty, free page in the log block is performed. This allows to process writing in an identical log block even when write requests continuously to a same page are issued.

Although the technique disclosed in JP-A 2002-366423 (KOKAI) allows, by utilizing the log block, data recovery after instantaneous power interruption and efficient use of data storage space of a flash memory, however, the technique fails to speed up writing operation in the block management discussed above.

Exemplary embodiments of a memory system according to the present invention will be described in detail below with reference to the accompanying drawings. It should be understood that the present invention is not limited to these exemplary embodiments.

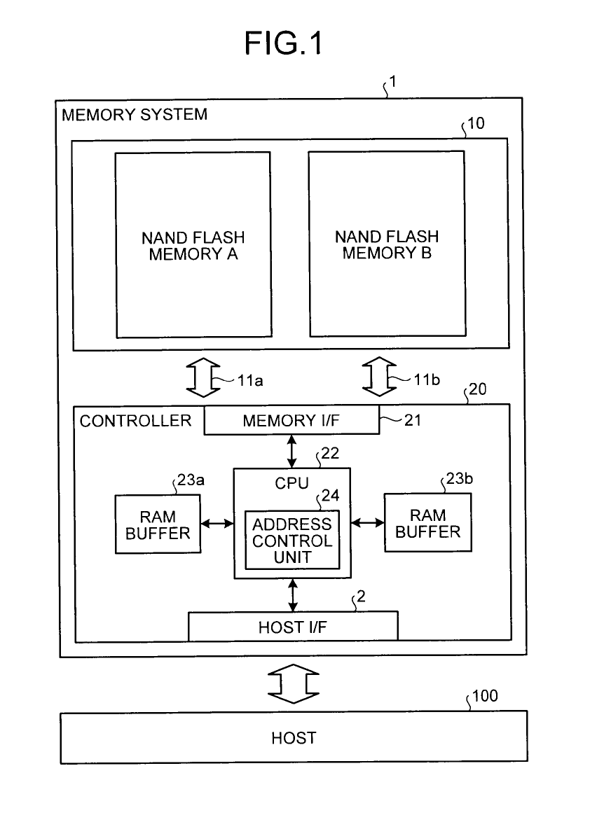

FIG. 1 is a block diagram illustrating a configuration example of a memory system according to an embodiment of the present invention. Referring to FIG. 1, a memory system 1 is connected to a host apparatus 100, such as a CPU core, via a memory connection interface I/F (host I/F) 2, such as an ATA interface, and functions as an external memory of the host apparatus 100. The memory system 1 includes a NAND flash memory (hereinafter, abbreviated as NAND memory) 10, which is an example of a non-volatile semiconductor memory, and a controller 20.

The NAND memory 10 includes two parallel operating elements (hereinafter, simply referred to as devices) A and B. The device A and the device B are connected to the controller 20 via I/O channels 11a and 11b, which are independent from each other, respectively. The controller 20 allows the devices A and B to perform parallel operations. Each of the devices A and B includes a plurality of physical blocks, and each of the physical blocks includes a plurality of physical pages. Each physical block is a data erasing unit while each physical page is a data write/read unit. The NAND memory 10 may be configured to store one bit per memory cell in the NAND memory 10 or to store multiple bits (data equal to or greater than two bits) per memory cell.

The controller 20 includes a memory I/F 21, which is a connection interface to the NAND memory 10, a CPU 22, RAM buffers 23a and 23b, which are two volatile semiconductor memories, an address control unit 24, and a host I/F 2. The RAM buffers 23a and 23b function as cache memories for data transfer between the host apparatus 100 and the NAND memory 10, memory for use as a working area, and the like. The CPU 22 develops and executes management computer program stored in the NAND memory 10 in semiconductor memory, such as the RAM buffer 23a and/or the RAM buffer 23b, thereby controlling data transfer between the host apparatus 100 and each NAND memory 10 via the RAM buffer 23a and/or the RAM buffer 23b and controlling elements in the controller 20. The address control unit 24, which is a functional element of the CPU 22, manages address conversion between logical addresses (e.g., LBA (logical block addressing)) for use by the host apparatus 100 and physical addresses in the NAND memory 10.

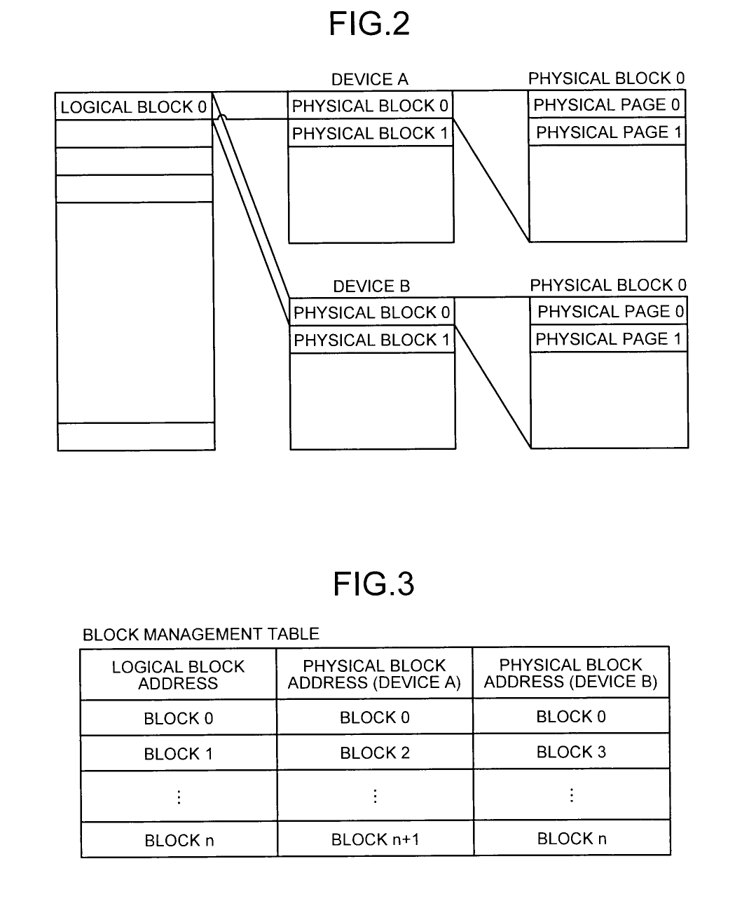

FIG. 2 illustrates logical-physical mapping providing correspondences between the logical addresses for use by the host apparatus 100 and the physical addresses in the NAND memory 10. As illustrated in FIG. 2, in the memory system, one logical block is subject to correspondence with one physical block in the device A and with one physical block in the device B. FIG. 2 illustrates an example where logical block 0 is subject to correspondence with physical blocks 0 of the devices A and B; however, a logical block is not necessarily subject to correspondence with physical blocks of the same number (the same address) of the devices A and B, and can be subject to correspondence with any physical block.

Physical blocks of the devices A and B subject to correspondence with an identical logical block are preferably configured such that data is contained in only either one of same physical pages of each physical block pair. Put another way, data that belongs to an identical logical block is stored in physical blocks subject to correspondence with the logical block such that pages that contain data do not overlap between the physical blocks. For instance, when logical block 2 is subject to correspondence with physical block 2 of the device A and to physical block 3 of the device B, if physical pages 0 to 24 of physical block 2 of the device A contain data, data is not contained in physical pages 0 to 24 of physical block 3 of the device B. Accordingly, storage capacity of the NAND memory 10 recognizable for the host apparatus 100 (user side) is only storage capacity corresponding to one device. In other words, the NAND memory is regarded and handled as one device by a user. As discussed above, this memory system does not employ page management of mapping logical pages to physical pages in a block but employs what is called block management.

FIG. 3 to FIG. 6 illustrate examples of address conversion tables for use by the address control unit 24. FIG. 3 illustrates an example of a block management table 30. The block management table 30 manages correspondences between logical block addresses (logical block numbers) and physical block addresses (physical block numbers) of the devices A and B. FIG. 3 illustrates an example where logical block 0 is subject to correspondence with physical block 2 of the device A and to physical block 3 of the device B.

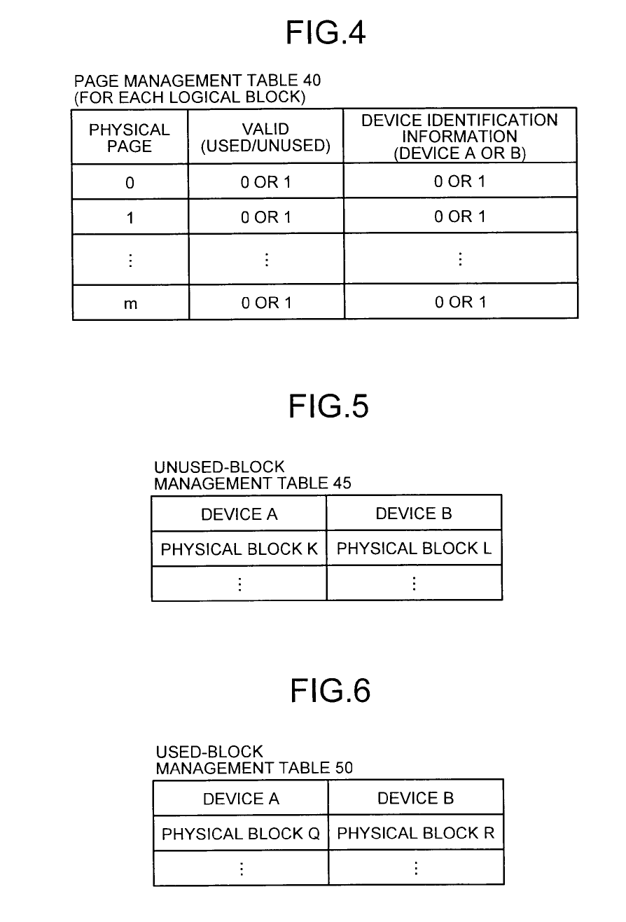

FIG. 4 illustrates an example of a page management table 40. Such a page management table as illustrated in FIG. 4 is provided for each of logical blocks that contain data. As discussed above, an identical logical block is subject to correspondence with one physical block of the device A and to one physical block of the device B. A page management table corresponding to one logical block contains management information related to physical pages in the physical blocks of the devices A and B subject to correspondence with the logical block. Because physical blocks of the devices A and B subject to correspondence with the identical logical block are managed such that only either one of same-numbered physical pages contains data, only entries (0 to m) of the number of physical pages in an identical physical block are provided in an identical page management table.

As illustrated in FIG. 4, the page management table 40 contains one bit of validity information (Valid) and one bit of device identification information for each of physical pages. The validity information indicates (Valid) whether each physical page contains valid data (used/unused). Validity information 0 indicates that no page in the devices A and B contains valid data while validity information 1 indicates that at least one page in the devices A and B contains valid data. Device identification information indicates which one of the devices A and B contains the valid data; for instance, device identification information 0 indicates that valid data is stored in the device A while device identification information 1 indicates that the valid data is stored in the device B.

FIG. 5 illustrates an example of an unused-block management table 45 for use in management of unused physical blocks. An unused physical block is a physical block, from which data has been erased and to which use is not allocated yet. The unused-block management table 45 contains block numbers (block addresses) of unused physical blocks of the devices A and B separately.

FIG. 6 illustrates an example of an used-block management table 50 for use in management of used blocks. An used block is a physical block, to which access is temporarily prohibited. The used-block management table 50 contains block numbers (block addresses) of used physical blocks of the devices A and B separately. Status of a physical block transits, for instance, from unused, in use, used, and unused.

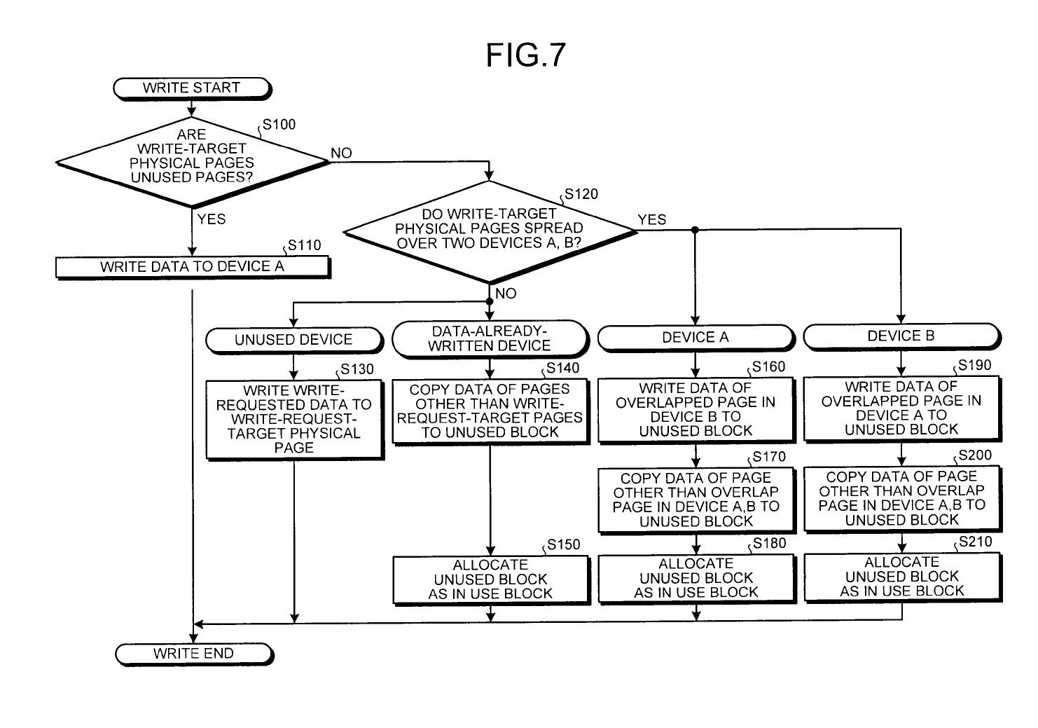

Writing operation according to the present embodiment will be described below with reference to the flowchart illustrated in FIG. 7. Upon receiving a write request from the host apparatus 100, the CPU 22 performs the following control by using the address control unit 24. First, the address control unit 24 determines whether one or more physical pages corresponding to one or more logical pages, or write-request-target, to which write has been requested, are unused (whether no valid data is stored in any one of the devices A and B) by using the management tables 30 and 40 illustrated in FIG. 3 and FIG. 4 (Step S100).

Put another way, the address control unit 24 checks validity information (Valid) pieces in the page management table 40 about all the one or more write-target physical pages (i.e., write-target logical pages) subject to correspondence with a logical block address, to which write has been requested, by using the block management table 30 illustrated in FIG. 3 and the page management table 40 illustrated in FIG. 4, and when all the Valid information pieces are 0, the address control unit 24 determines that the write-target physical pages are unused. If it is determined that the write-target logical pages are unused, the address control unit 24 selects a physical block number subject to correspondence with the logical block address, to which write has been requested, of the devices A and B by using the block management table 30 illustrated in FIG. 3, and writes write data, which is specified by the write request, to the pages of a physical block corresponding to the thus-selected physical block number of a predetermined one (e.g., the device A) of the devices (Step S110).

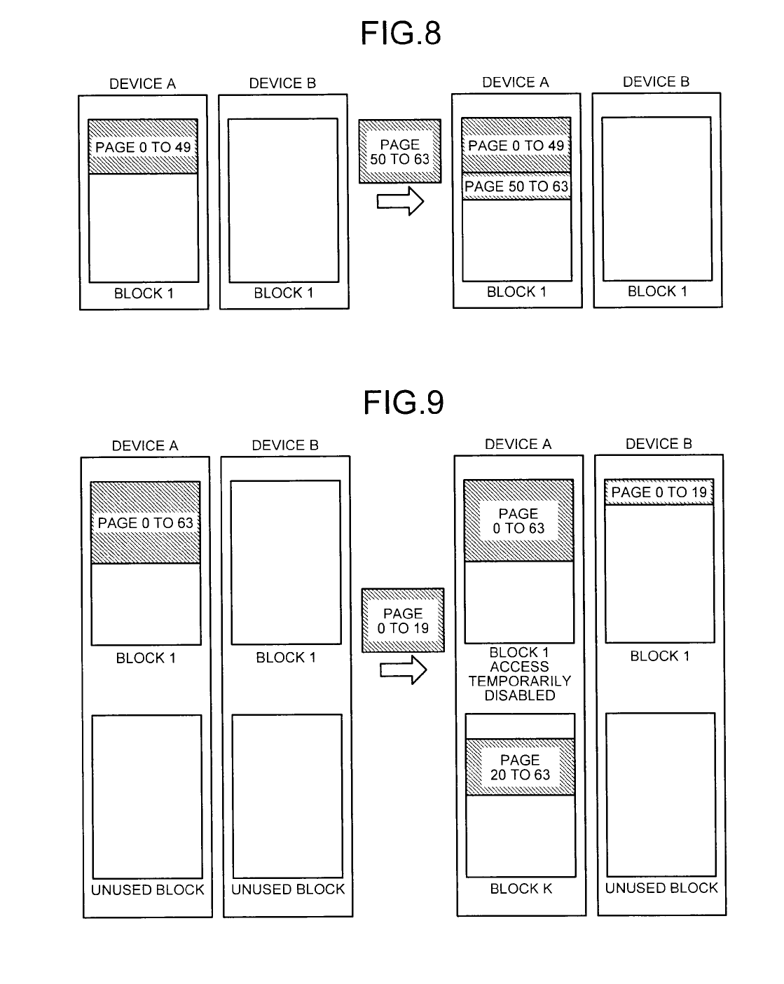

FIG. 8 illustrates an example of the operation performed at Step S110. In the example illustrated in FIG. 8, a write request to pages 50 to 63 of physical block 1, in which pages 0 to 49 contain data, of the device A has been issued. In this case, data is to be written to pages 50 to 63 of physical block 1 of the device A.

When a result of determination made at Step S110 in FIG. 7 is NO, or, specifically, if one or more physical pages subject to correspondence with one or more write-request-target logical pages contain data, the address control unit 24 determines whether the write-request-target physical pages spread over the two devices, or the devices A and B, by using Valid information and device identification information in the page management table 40 (Step S120). FIG. 9 illustrates an example case where a result of determination made at Step S120 is NO. In the example illustrated in FIG. 9, a write request to pages 0 to 19 of physical block 1, in which pages 0 to 63 contain data, of the device A has been issued. In this case, access to the one device rather than access extending over the two devices, or the devices A and B, is to be made.

In such a case, the address control unit 24 writes write data to one device, in which write-requested pages are unused, of the devices (Step S130). In the example illustrated in FIG. 9, because pages 0 to 19 of the device B are unused, data is written to pages 0 to 19 of the device B. Specifically, this writing operation is performed by writing the write data stored in the RAM buffer 23b to pages 0 to 19 of physical block 1 of the device B via the memory I/F 21 and the I/O channel 11b.

Concurrent with this writing operation to the device B, on the device A, in which the write-request-target pages contain data, copy operation of writing data that is stored in other pages than the write-request-target pages to an unused, free physical block of the same device A is performed (Step S140). The unused, free block is selected from unused blocks recorded in the unused-block management table 45 illustrated in FIG. 5. Meanwhile, the copy operation to the unused block is performed by copying data to the same page addresses as the write-request-target page addresses rather than to a head page of the unused block. In the example illustrated in FIG. 9, data stored in physical pages 20 to 63 of physical block 1 of the device A is copied to physical pages 20 to 63 of physical block K, which is an unused block, of the device A. This copy operation is performed by reading data stored in physical pages 20 to 63 of physical block 1 of the device A out to the working area in the RAM buffer 23a via the I/O channel 11a and the memory I/F 21 and writing the data written to the RAM buffer 23a to physical pages 20 to 63 of physical block K of the device A via the memory I/F 21 and the I/O channel 11a. Because the RAM buffer 23a and the RAM buffer 23b, and the I/O channel 11a and an I/O channel 11n, both of which belong thereto, are independent from each other, the operation at Step S130 and the operation at Step S140 can be performed in parallel at high speed.

Upon completing the write to the unused block, status of a copy source block (physical block 1 of the device A in FIG. 9), from which the data has been copied, is temporarily changed to used, by which access to the copy source block is disabled. Specifically, a block number 1 corresponding to physical block 1 is added to the column of the device A in the used-block management table 50 illustrated in FIG. 6.

Subsequently, the address control unit 24 updates the block management table 30 and the page management table 40 to reflect the write performed on the device B and the copy operation performed on the device A. Specifically, in the example illustrated in FIG. 9, if the physical block that is subject to correspondence with logical block 1 is changed from physical block 1 to physical block K, the block management table 30 is updated so as to correspond to this change. Because storing-related change of storing pages 0 to 19 in the device B while storing pages 20 to 63 in the device A has been made, portion of the page management table 40 related to logical block 1 is updated to reflect this change.

Thereafter, the used block is deleted from the used-block management table 50 and recorded in the unused-block management table 45 illustrated in FIG. 5 as an unused block. In the example illustrated in FIG. 9, physical block 1, or the copy source, of the device A is the used block. Accordingly, after deletion of the used block, or physical block 1 of the device A, physical block 1 of the device A is added to the unused-block management table 45.

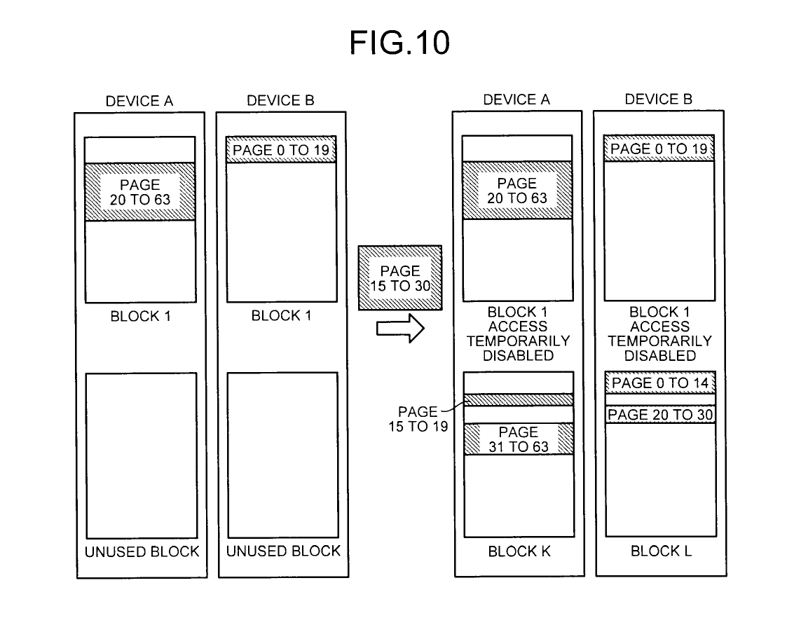

In contrast, if a result of determination made at Step S120 in FIG. 7 is YES, or, specifically, if write-request-target physical pages spread over the two devices, or the devices A and B (the write-request-target pages are busy in the two devices, or the devices A and B), the address control unit 24 performs the following operations. FIG. 10 illustrates an example case where a result of determination made at Step S120 is YES. In the example illustrated in FIG. 10, in a state where pages 20 to 63 of physical block 1 of the device A contain data and pages 0 to 19 of physical block 1 of the device B contain data, a write request to pages 15 to 30 has been issued; that is, an access extending to the two devices, or the devices A and B, is to be made.

In such a case, the address control unit 24 writes a portion of the write-requested data, or specifically data of pages that overlap with busy pages of the device B, to an unused, free block of the block A first (Step S160). The unused, free block is selected from unused blocks recorded in the unused-block management table 45 illustrated in FIG. 5. Meanwhile, the writing operation to the unused block is performed by writing data to the same page addresses as the write-request-target page addresses rather than to a head page of the unused block. In the example illustrated in FIG. 10, in a state where pages 0 to 19 of block 1 of the device B contain data, write to pages 15 to 30 has been requested. Accordingly, a portion of the data to be written to pages 15 to 30, or specifically data of pages 15 to 19 that overlap with the device B, is written to pages 15 to 19 of an unused, free block K of the device A.

Concurrent with the data writing operation performed on the device A at Step S160, operation at Step S190 is performed. At Step S190, a portion of the write-requested data, or specifically data of pages that overlap with busy pages of the device A, is written to an unused, free block of the block B. In the example illustrated in FIG. 10, in a state where pages 20 to 63 of block 1 of the device A contain data, write to pages 15 to 30 has been requested. Accordingly, a portion of the data to be written to pages 15 to 30, or specifically data of pages 20 to 30 that overlap with the device A, is written to pages 20 to 30 of an unused, free block L of the device B.

The operation at Step S160 is performed by writing write-requested data that is temporally stored in the RAM buffer 23a to the device A via the memory I/F 21 and the I/O channel 11a while the operation at Step S190 is performed by writing write-requested data that is temporally stored in the RAM buffer 23b to the device B via the memory I/F 21 and the I/O channel 11b. Accordingly, the operations at Step S160 and Step S190 can be performed in parallel at high speed. Immediately after the operation at Step S160 ends, the operation at Step S170 is performed. Immediately after the operation at Step S190 ends, the operation at Step S200 is performed.

When a data write to the devices A and B is completed as discussed above, data of other pages than the write-requested pages is copied to unused, free blocks, to which the write has been performed in each of the devices. More specifically, on the device A, a portion of the data stored in the busy pages of the device A, the portion being data of other pages than the pages that overlap with the write-requested data, is copied to the unused physical block of the device A (Step S170) while, on the device B, a portion of the data stored in the busy page of the device B, the portion being data of other pages than the pages that overlap with the write-requested data, is copied to the unused physical block of the device B (Step S200).

In the example illustrated in FIG. 10, on the device A, data stored in pages 31 to 63, which are remainder of block 1 apart from page 15 to 30 corresponding to the write-requested pages, is copied to physical blocks 31 to 63 of physical block K, which is the unused block of the device A (Step S170). This copy operation is performed by reading the data stored in physical pages 31 to 63 of physical block 1 of the device A out to the working area in the RAM buffer 23a via the I/O channel 11a and the memory I/F 21 and writing the data written to the RAM buffer 23a to physical pages 31 to 63 of physical block K of the device A via the memory I/F 21 and the I/O channel 11a.

Meanwhile, on the device B, data stored in pages 0 to 14, which are remainder of block 1 apart from page 15 to 30 corresponding to the write-requested pages, is copied to physical blocks 0 to 14 of physical block L, which is the unused block of the device B (Step S200). This copy operation is performed by reading the data stored in physical pages 0 to 14 of physical block 1 of the device B out to the working area in the RAM buffer 23b via the I/O channel 11b and the memory I/F 21 and writing the data written to the RAM buffer 23b to physical pages 0 to 14 of physical block L of the device B via the memory I/F 21 and the I/O channel 11b.

When the write to the unused blocks ends, status of the copy source blocks (physical blocks 1 of the devices A and B in FIG. 10) are temporarily changed to used, by which access to the copy source blocks is disabled. Specifically, a block number 1 corresponding to physical block 1 is recorded to each of the columns of the devices A and B in the used-block management table 50 illustrated in FIG. 6.

Subsequently, the address control unit 24 updates the block management table 30 and the page management table 40 to reflect the writing operation performed on the devices A and B and the copy operation performed on the devices A and B (Step S180, Step S210). Specifically, in the example illustrated in FIG. 10, when the physical block subject to correspondence with logical block 1 is changed from physical block 1 to physical block K on the device A and from physical block 1 to physical block L on the device B, the block management table 30 is updated to reflect the change. Because storing-related change of storing pages 0 to 14 in the device B, storing pages 15 to 19 in the device A, storing pages 20 to 30 in the device A, and storing pages 31 to 63 in the device A has been made, portion of the page management table 40 related to logical block 1 is updated to reflect the change.

Thereafter, the used block is deleted from the used-block management table 50 and added to the unused-block management table 45 illustrated in FIG. 5 as an unused block. In the example illustrated in FIG. 9, physical blocks 1, or the copy source, of the devices A and B are the used blocks. Accordingly, after deletion of the used blocks, or physical blocks 1 of the devices A and B, physical blocks 1 of the devices A and B are added to the unused-block management table 45. Note that in FIG. 7, the order in which the operation at Step S160 and the operation at Step S170 are to be performed can be reversed, as well as the order in which the operation at Step S190 and the operation at Step S200 are to be performed can be reversed.

As discussed above, in a first embodiment, there are provided the memory devices A and B that includes physical blocks, in which a physical block of the device A and a physical block of the device B are subject to correspondence with an identical logical block, and are configured such that block-to-block data move in and data write to and from the memory devices A and B can be performed in parallel. Accordingly, block-to-block data move and data writing operation involved in data write to a data-already-written area can be performed at higher speed and higher efficiency. Providing the memory devices A and B that share the logical address increases useful device life for a user who regards the memory devices A and B as one device, thereby improving integrity and reliability of data.

### Second Embodiment

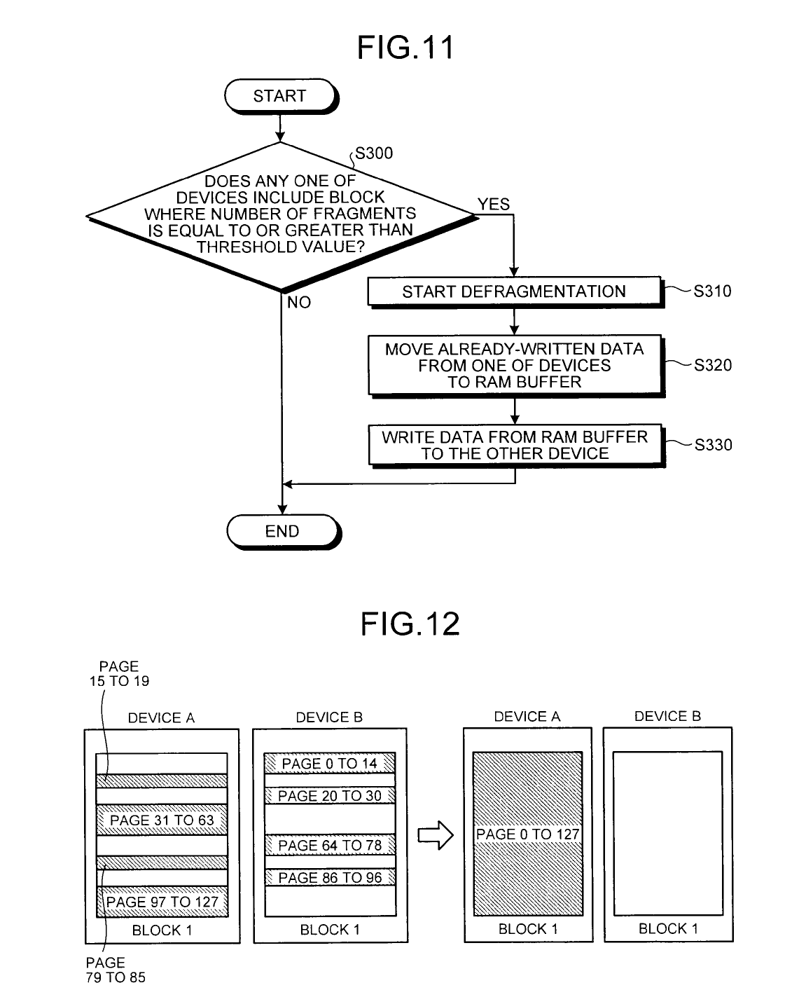

A second embodiment of the present invention will be described with reference to FIG. 11 and FIG. 12 below. It is anticipated that performing the data write and block-to-block data move discussed in the first embodiment can bring about such a state as illustrated in FIG. 10 where data areas are distributed in blocks of the devices A and B. To this end, in the second embodiment, if distribution number of data areas, or fragments, is determined to be greater than a predetermined threshold value at a time when writing operation is completed, the CPU 22 performs defragmentation while no access is being made to the NAND memory 10.

FIG. 11 is a flowchart illustrating a sequence of operations of defragmentation. Upon completing of data writing operation, the CPU 22 determines whether there is a physical block where the distribution number of page fragments (the number of divisions) is greater than the threshold value in the devices A and B by using the page management table 40 and block management table 30 (Step S300). If there is a block where the number of divisions is greater than the threshold value, the CPU 22 starts defragmentation of the block where the number of divisions is greater than the threshold value (Step S310). Note that the defragmentation is performed while access, such as write/read, to the NAND memory 10 is not being made. A state where data areas are fragmented in the devices A and B is illustrated on the left-hand portion of FIG. 12. With the technique according to the first embodiment, the number of fragments in the device A and that in the device B are basically equal to each other.

The defragmentation is performed by reading out data in a block of one of the devices to the RAM buffer 23a (or 23b) first (Step S320). Subsequently, the data read out to the RAM buffer 23a (or 23b) is written to a block subject to correspondence with same logical address in the other device (Step S330). In this write, the page, from which the data is read out, and the page, to which the data is written, are equal to each other. When the defragmentation as discussed above is completed, data is erased from block 1 of the device B. Thereafter, block 1 is recorded as an unused block.

The defragmentation can alternatively be performed by comparing an amount of data stored in a block of the device A with that in a block of the device B, and, based on a result of comparison, writing data in increasing order of the data amount. This scheme leads to speedup of the defragmentation. The defragmentation can alternatively be performed by writing data of blocks where number of fragments is greater than a predetermined number in both of the devices A and B to another unused blocks of one of the devices. In this case, when the defragmentation is completed, after erasing data from blocks of the devices A and B, from which data has been read, the blocks are recorded as unused blocks.

As discussed above, in the second embodiment, if the devices A and B include blocks where the number of divisions is greater than the threshold value, the defragmentation of consolidating data into one of the devices is performed. Accordingly, such access as illustrated in FIG. 10 that extends to the two devices, or the devices A and B, is less likely to occur in writing operation, causing access illustrated in FIG. 8 or FIG. 9 to occur more frequently. This can lead to speedup of the writing operation.

Data management method by using the management table is not limited to those described with reference to FIG. 3 to FIG. 6, and any data management method can be employed. In the embodiments discussed above, whether each page is assigned or unused and in which one of the devices A and B data is stored are determined by using Valid information and device identification information contained in the page management table 40; however, alternatively, whether each page is assigned or unused and in which one of the devices A and B data is stored can be determined based on a result of search performed to determine whether each page in a target block of each of the devices A and B is an erased page that contains no data. In the embodiments, two NAND memories that share logical addresses have been used; however, similar write control and block-to-block data move control to those discussed above can be employed by using three or more NAND memories that share logical addresses.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory system comprising:
non-volatile first and second memories that are capable of operating in parallel and respectively have a plurality of physical blocks which respectively include a plurality of pages; and
a controller that controls reading and writing from and to the first and second memories, wherein
the controller includes:
an address control unit that performs address management of managing correspondences between logical blocks and the physical blocks of the first and second memories such that an identical logical block is subject to correspondence with a respective physical block of the first and second memories, and storing data of pages included in the identical logical block such that, between physical blocks subject to correspondence with the identical logical block, pages including data do not overlap with each other,
the address control unit includes:
a first control unit that performs, when a write-requested page is unused in both of the first and second memories, first control of writing write-requested data to the write-requested page in any one of the first and second memories;
a second control unit that performs, when the write-requested page is in use in any one of the first and second memories, second control of writing write-requested data to the write-requested page of one of the memories that is not in use, and writing storage data of page other than the write-requested page of the memory that is in use, to an unused physical block of the memory side that is in use; and
a third control unit that performs, when the write-requested page is in use in both of the first and second memories, third control of writing to an unused physical block of the first memory side, data of a page that is overlapped with a page used in the second memory within the write-requested data, and storage data of page other than a page that is overlapped with the write-requested data within the storage data of a page used in the first memory, and of writing to an unused physical block of the second memory side, data of a page that is overlapped with a page used in the first memory within the write-requested data, and storage data of a page other than a page that is overlapped with the write-requested data within the storage data of a page used in the second memory, and
the second and third control units perform operation to the first memory and operation to the second memory in parallel.

2. The memory system according to claim 1, wherein
the controller includes first and second buffer memories that perform data buffering between a host apparatus and the first and second memories, and
the second and third control units perform operation to the first memory and operation to the second memory in parallel by using the first and second buffer memories.

3. The memory system according to claim 1, wherein
after performing the second control, the second control unit performs fourth control of changing correspondences between the logical block and the physical blocks of the first and second memories, and
after performing the third control, the third control unit performs fifth control of changing correspondences between the logical block and the physical blocks of the first and second memories.

4. The memory system according to claim 3, wherein
the address control unit includes:
a first management table that manages the correspondences between the logical blocks and the physical blocks of the first and second memories;
a second management table that manages whether each page contains valid data and manages that which one of the first and second memories contains the valid data of each page for each logical block as a unit; and
a third management table that manages unused physical blocks, and
the address control unit performs the address management and the first through fifth control based on the first through third management tables.

5. The memory system according to claim 4, wherein
the second control unit performs the fourth control by updating the first management table, and thereafter updates the second management table and the third management table so as to correspond to the second control, and
the third control unit performs the fifth control by updating the first management table, and thereafter updates the second management table and the third management table so as to correspond to the third control.

6. The memory system according to claim 1, wherein
after performing the second control, the second control unit temporarily access inhibits physical block of the memory, in which the write-requested page has been in use, and
after performing the third control, the third control unit temporarily access inhibits a physical block of the first memory, in which the write-requested page has been in use, and a physical block of the second memory, in which the write-requested page has been in use.

7. The memory system according to claim 6, wherein the address control unit changes the status of the physical block, which has temporarily been access inhibited, to unused to manage the physical block as an unused physical block.

8. The memory system according to claim 6, wherein the address control unit includes a fourth management table for use in managing the physical block, which has temporarily been access inhibited.

9. The memory system according to claim 1, further comprising a fourth control unit that performs, when the first and second memories include physical blocks, in which distribution number of data is equal to or greater than a predetermined threshold value, defragmentation by consolidating data of one physical block in one memory of the first and second memories, into data of other physical block of the other memory, the one physical block and the other physical block being correspondence with the identical logical block.

10. The memory system according to claim 9, wherein the fourth control unit performs the defragmentation while an access that includes write/read is not being made to any one of the first and second memories.

11. The memory system according to claim 9, wherein the fourth control unit compares between amounts of data stored in the physical blocks that are subject to correspondence with the identical logical block, and, based on a result of the comparison, performs the defragmentation by consolidating data in one physical block having a smaller amount of data of the physical blocks into data of the other physical block of the physical blocks.

12. The memory system according to claim 9, wherein the defragmentation is performed by writing data stored in the two physical blocks that are subject to correspondence with the identical logical block to an unused physical block of any one of the first and second memories.

13. A memory system managing method, in which a memory system includes a non-volatile first and second memories that are capable of operating in parallel and respectively have a plurality of physical blocks which respectively include a plurality of pages, the method comprising:
performing address management of managing correspondences between logical blocks and the physical blocks of the first and second memories such that an identical logical block is subject to correspondence with a respective physical block of the first and second memories, and storing data of pages included in the identical logical block such that, between physical blocks subject to correspondence with the identical logical block, pages including data do not overlap with each other;
performing, when a write-requested page is unused in both of the first and second memories, first control of writing write-requested data to the write-requested page in any one of the first and second memories;
performing, when the write-requested page is in use in any one of the first and second memories, second control of writing write-requested data to the write-requested page of one of the memories that is not in use, and writing storage data of page other than the write-requested page of the memory that is in use, to an unused physical block of the memory side that is in use;
performing, when the write-requested page is in use in both of the first and second memories, third control of writing to an unused physical block of the first memory side, data of a page that is overlapped with a page used in the second memory within the write-requested data, and storage data of page other than a page that is overlapped with the write-requested data within the storage data of page used in the first memory, and of writing to an unused physical block of the second memory side, data of a page that is overlapped with a page used in the first memory within the write-requested data, and storage data of page other than a page that is overlapped with the write-requested data within the storage data of page used in the second memory; and
performing operation to the first memory and operation to the second memory in parallel, during performing the second and third control.

14. The memory system managing method according to claim 13, wherein
after the second control has been performed, the correspondences between the logical block and the physical blocks of the first and second memories are changed, and
after the third control has been performed, correspondences between the logical block and the physical blocks of the first and second memories are changed.

15. The memory system managing method according to claim 13, wherein
after performing the second control, temporarily access is inhibited to physical block of the other memory, in which the write-requested page has been in use, and
after performing the third control, temporarily access is inhibited to physical block of the first memory, in which the write-requested page has been in use, and physical block of the second memory, in which the write-requested page has been in use.

16. The memory system managing method according to claim 15, wherein the physical block, which has temporarily been access inhibited, is managed as an unused physical block.

17. The memory system managing method according to claim 13, wherein when the first and second memories include physical blocks, in which distribution number of data is equal to or greater than a predetermined threshold value, defragmentation is performed by consolidating data of one physical block in one memory of the first and second memories, into data of other physical block of the other memory, the one physical block and the other physical block being correspondence with the identical logical block.

18. The memory system managing method according to claim 17, wherein the defragmentation is performed while an access that includes write/read is not being made to any one of the first and second memories.

19. The memory system managing method according to claim 17, wherein, in the defragmentation process, comparison between amounts of data stored in the physical blocks that are subject to correspondence with the identical logical block is performed and, based on a result of the comparison, data in one physical block having a smaller amount of data of the physical blocks is consolidated into data in the other physical block of the physical blocks.

20. The memory system managing method according to claim 17, wherein in the defragmentation process, data stored in the physical blocks that are subject to correspondence with the identical logical block is written to an unused physical block of any one of the first and second memories.
